(19) United States
(12) Patent Application Publication
(10) Pub. No.: US 2021/0010601 A1
(43) Pub. Date: Jan. 14, 2021

(54) SEALING APPARATUS

(71) Applicant: VALUE 4 U LIMITED, Aberdeen (GB)

(72) Inventors: Bruce Logan, Aberdeen (GB); Colin Laird, Aberdeen (GB)

(73) Assignee: VALUE 4 U LIMITED, Aberdeen (GB)

(21) Appl. No.: 16/968,687

(22) PCT Filed: Feb. 18, 2019
(86) PCT No.: PCT/GB2019/050427

§ 371 Date: Aug. 10, 2020

(30) Foreign Application Priority Data
Feb. 16, 2018 (GB) 1802537.9

(51) Int. Cl. F16K 1/226; F16J 15/12

(52) U.S. Cl. CPC F16K 1/2261; F16J 15/12

(57) ABSTRACT

The present invention concerns a composite sealing component. The composite sealing component has a plurality of planar sealing elements 2, 3, one or more of sealing elements 2 having a higher compressibility than adjacent sealing elements 3 of relatively low compressibility. The sealing elements of relative low compressibility 3 are configured to maintain a fixed spacing to limit compression of the one or more sealing elements 2 of relatively high compressibility provided therebetween.

The present invention relates to sealing apparatus, and more particularly to a seal ring for use with, for example, valves used in the oil and gas industry. It will be appreciated however that the sealing apparatus of the present invention is not exclusive to the oil and gas industry and may be utilised in alternative fields.

One relevant oil and gas application concerns use in butterfly valves, and more particularly triple offset valves, which have a disc-shaped valve member that rotates between open and closed positions in a valve orifice about an axis to regulate the flow of fluid through the valve.

In this connection, UK Patent No. GB1140702 discloses one such butterfly valve for connecting in series with a fluid pipeline, the valve comprising an annular body portion defining a valve orifice and a disc-shaped valve assembly comprising a shaft mounted disc body, sealing ring, disc clamping plate and “n” securing bolts. The disc shaped valve assembly is rotatably mounted in the orifice and has a frusto-conical side face. The disc-shaped valve assembly is moreover mounted to a shaft which extends perpendicular to the through-axis of the annular valve body. An external actuator is provided for rotating the disc-shaped valve member between an open position where it extends parallel to the through-axis of the valve body, and a closed position where it extends perpendicular to the through-axis of the valve body across the valve orifice.

When in the closed position, the frusto-conical side face of the disc-shaped valve assembly seals against a complementary surface of an annular valve seat fitted concentrically to the valve body around the orifice therein.

The disc-shaped valve assembly sealing ring and valve seat inevitably wear against each other as the valve is opened and closed, to the extent that the valve begins to leak when closed.

In this connection, FIGS. 1a and 1b show a sealing ring stack arrangement 1 widely used by many manufacturers. The known sealing ring stack arrangement comprises interleaving graphite rings 2 with metal rings 3. As such, rather than a single sealing component as disclosed in GB1140702, a composite stack is provided having, in this case, three graphite rings 2 spaced apart by metal rings 3.

However, the applicants have found that during assembly of valves with such a composite sealing ring stack, the rings are over-compressed onto the body of the disc-shaped valve assembly, so that the seal material of each ring 2 partially extrudes radially outwardly of the valve seal ring stack. If the stack is over tightened, excessive amounts of seal material can be extruded and deposited on the face of the valve body seat, particularly as the disc member rotates to close the valve and the seal is activated.

When the valve is opened again, the sealing material of each ring 2 should retract back between rings 3 as the pressure is released. However, when the seal material does not retract sufficiently due to excessive initial compression, there is a loss of seal material volume at the edges. Each time the valve is actuated this same problem occurs, resulting in that more and more seal material volume is lost causing the seal to eventually fail.

The present invention seeks to alleviate the problems associated with such arrangements.

According to the present invention there is provided a composite sealing component comprising: a plurality of planar sealing elements, one or more of sealing elements having a higher compressibility than adjacent sealing elements of relatively low compressibility; wherein the sealing elements of relative low compressibility are configured to maintain a fixed spacing to limit compression of the one or more sealing elements of relatively high compressibility provided therebetween. In this manner, an enhanced composite seal component is provided, which is less vulnerable to wear.

Preferably, the sealing elements of relative low compressibility take the form of a series of flanges, between which the sealing elements of relative high compressibility are provided. In this regard, the sealing elements of relative low compressibility are preferably formed by machining circumferential slots into the periphery of a solid ring to define said series of flanges.

Preferably, a plurality of sealing elements of relative low compressibility are coupled together, one or more of the facing surfaces of the sealing elements of relative low compressibility being profiled to define said spacing there-between.

Conveniently, certain of the sealing elements of relative low compressibility have a stepped profile to define slots for housing said sealing elements of relative high compressibility. As such, a composite stack can be built up by coupling a plurality of such sealing elements together.

Support spacers may be provided between the sealing elements of relative low compressibility, the support spacers keeping the sealing elements of relative low compressibility apart to define slots for housing the sealing elements of relative high compressibility.

Preferably, the sealing elements of relative low compressibility and support spacers are rings, with the support spacers having a reduced outer diameter compared with the sealing elements of low compressibility. The space defined radially outwardly of the spacers between the sealing elements of relative low compressibility is used for housing the sealing elements of relative high compressibility.

Conveniently, the sealing elements of relative high compressibility are interleaved with the sealing elements of relative low compressibility to form a composite stack.

Whilst the elements of the composite sealing component may be coupled using any suitable means, preferably they are coupled together with adhesive. Alternatively, the elements may be hot spot welded together. The spot weld may be carried out at 3 positions radially.

In preferred embodiments, the composite sealing component is a sealing ring.

Conveniently, three to five sealing elements of relative high compressibility are provided within the composite sealing component. In preferred embodiments, three sealing elements of relative high compressibility are supported by four sealing elements of relative low compressibility.

Preferably, if there are n sealing elements of relative high compressibility, n of the n+1 sealing elements of relative low compressibility are profiled on one face.

In preferred embodiments, the sealing elements of relative high compressibility are formed of any one of graphite, PTFE, PVC or rubber.

Furthermore, the sealing elements of relative low compressibility may be formed of any one of Steel, 316L Stainless Steel, Inconel, Duplex, Alloy Bronze.

Conveniently, the sealing component outer sealing profile presents a flush surface across the different planar sealing elements of relative low and high compressibility. That is, the outer sealing profile of the sealing component is formed to be substantially flush in a non-activated state of the composite component, the outer surfaces of the relative low and high compressibility sealing elements presenting a common surface. In the case of a sealing ring, the outer sealing profile is an annular surface.

In a further aspect of the present invention there is provided a method for assembling a butterfly valve having a composite sealing component according to any preceding claim, the method comprising the steps: installing the composite sealing component in position in the valve on the valve's disc body; partially tightening a disc seal cover plate so that the composite sealing component is free to move into the correct position when the disc assembly comprising the disc body and composite sealing component is rotated by the valve shaft to the closed position correctly aligning the composite sealing component against a valve body seat; closing the valve with a minimum torque setting to ensure correct seal assembly alignment and test for leakage, repeating the open/close/leakage test process with increasing torque up to 75% MAST; fully tightening the disc seal plate to hold the composite sealing component in position once alignment is confirmed and all air leaks are eliminated. In this regard, MAST is Maximum Allowable Stem Torque.

Embodiments of the present invention will now be described by way of example and with reference to the accompanying drawings, of which:

FIGS. 1a and 1b shows a known composite seal ring assembly, with FIG. 1b showing an enlarged cross-sectional view;

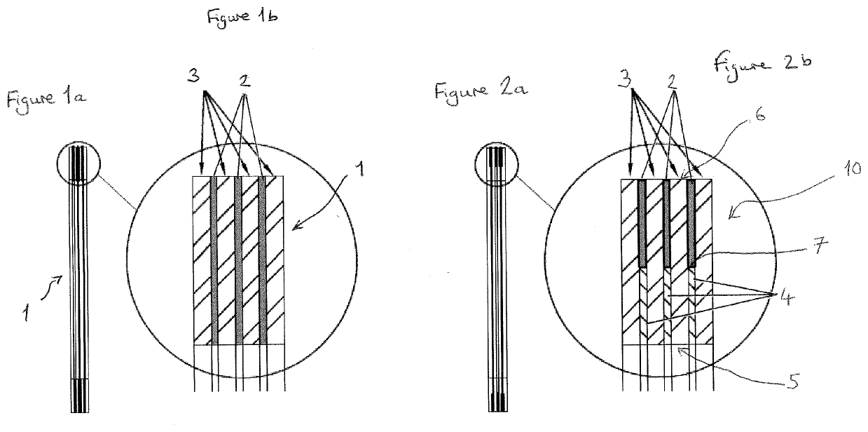

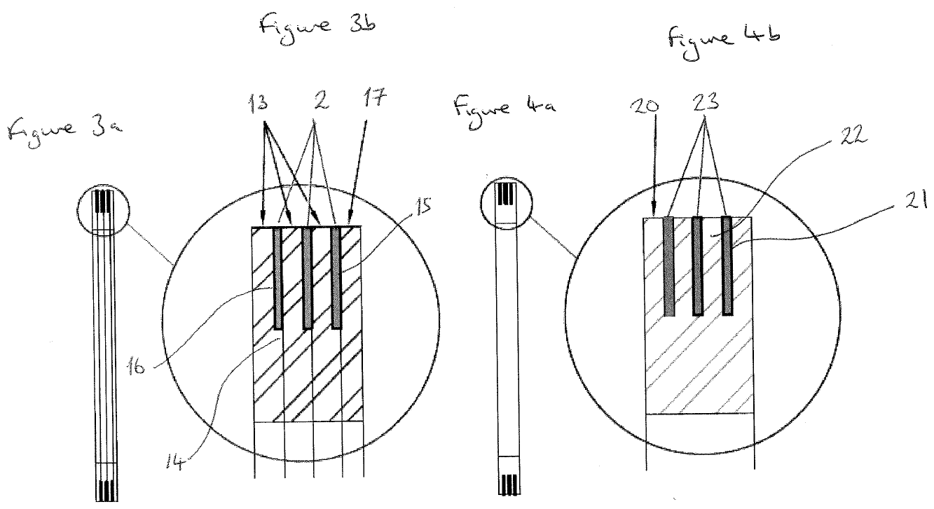

FIGS. 2a and 2b show a composite seal ring assembly according to a first embodiment of the present invention, with FIG. 2b showing an enlarged cross-sectional view;

FIGS. 3a and 3b show a composite seal ring assembly according to a second embodiment of the present invention, with FIG. 3b showing an enlarged cross-sectional view;

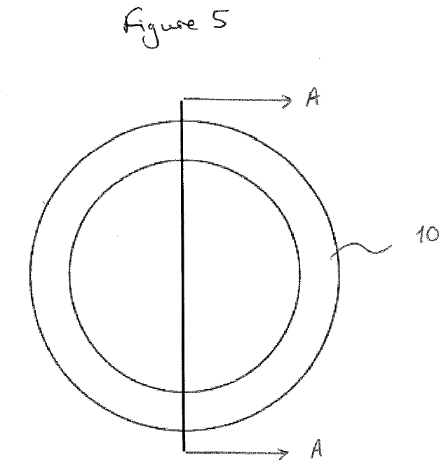

FIGS. 4a and 4b show a composite seal ring assembly according to a third embodiment of the present invention, with FIG. 4b showing an enlarged cross-sectional view; and

FIG. 5 shows a front view of the composite seal ring assembly of the above figures;

FIGS. 1a and 1b show a known composite seal ring assembly 1. The seal ring has a laminate construction, with three graphite seal rings 2 being interleaved between metal seal rings 3. The graphite seal rings and metal seal rings have the same outer and inner diameters. On testing this design, it was found that when assembled into a valve, there was a potential to over compress the seal ring assembly 1, meaning that excessive graphite seal material would be extruded on activation of the valve during its use. Such extruded material would not all retract back between the metal seal rings 3, leading to a loss of graphite volume at the edges. Repeated activation of the valve resulted in more and more seal material volume being lost, ultimately leading to failure of the seal assembly as a whole.

As such, FIGS. 2 to 4 show embodiments of the invention which seek to resolve the above problem. In FIGS. 2a and 2b, the metal seal rings 3 are spaced apart using spacer elements 4. The spacer elements are rings which have an inner bore diameter that matches the inner bore diameter of the metal seal rings 3 and an outer diameter that matches the inner diameter of the graphite seal rings 2. The outer diameter of the graphite seal rings of this embodiment match the outer diameter of the metal seal rings 3 such that the composite stack 10 formed from the graphite seal rings, metal seal rings and spacer rings has substantially flush outer and inner edge faces 6, 5. The spacer rings 4 ensure that the graphite seal rings are not over-compressed during assembly and can undergo a certain limited compression during activation of a valve in which the composite seal stack 10 is provided. The edge 7 of the outer diameter of the spacer ring furthermore presents a stop to expansion of the graphite seal ring 3 inwardly, thereby enhancing the desired outer expansion of the graphite seal ring at its radial outer periphery during activation of a valve in which the stack is assembled. In one example, the metal seal rings may have an inner diameter of 65 mm and an outer diameter of 86 mm and a thickness of 1 mm. The spacer rings may have an inner diameter of 65 mm and an outer diameter of 72 mm and a thickness of 1 mm, and the graphite seal rings may have an inner diameter of 73 mm and an outer diameter of 86 mm and a thickness of 1.2 mm.

FIGS. 3a and 3b show a second embodiment of the present invention, where certain of the metal seal rings 13 are profiled to incorporate a raised section 14. On assembly, the raised section of one such metal seal ring abuts the face of an adjacent metal seal ring so that slots 15 are formed where the reduced profile section 16 is spaced from the adjacent metal seal ring. The graphite seal rings 2 can be provided within these slots.

An end metal seal ring 17 having no profiled section closes off the composite stack. As above, the raised sections ensure that compression of the stack, including the sealing materials, is controlled on valve assembly and valve activation to ensure an optimum extrusion and retraction of seal material is achieved. All layers and rings may be glued together. Whilst three seal rings 2 are shown, clearly the composite stack can be built up to have any number, depending on the requirements.

When the seal ring stack is being fitted in a valve, the end support ring 17 may be partially tightened while the valve is opened and closed to allow the stack to be properly seated on the valve body seat, creating a full contact seal. When the seal ring stack is aligned then the end support ring may be fully tightened.

FIGS. 4a and 4b show a third embodiment of the present invention where the seal assembly 20 comprises a solid ring, into which circumferential slots or grooves 21 have been formed, for example by machining. In this way, a plurality of flanges 22 are formed which act as support sealing ring elements having a relatively low compressibility. Sealing elements 23 of relative high compressibility can be provided between such flanges. In this regard, the sealing elements 23 may be formed by filling the grooves with graphite or other seal material.

The sealing elements 22 and 23 are hence respectively formed of relatively low and relatively high compressibility materials, for example metal for the former and graphite for the latter, although suitable alternatives may of course be used.

The composite sealing component of the present invention assists to prevent undesirable movement of the components of the assembly or over-extrusion of the sealing material, thereby helping to maintain, for example, cone shaped seal configurations in triple offset valves.

In the above embodiments, the seal ring assembly is made up of a combination of relatively low compressibility sealing elements and relatively high compressibility sealing elements. The sealing elements of relative high compressibility may be formed of any one of graphite, PTFE, PVC or rubber and the sealing elements of relative low compressibility may be formed of any one of Steel, 316L Stainless Steel, Inconel, Duplex, Alloy Bronze.

What is claimed:

1. A composite sealing component comprising:
a plurality of planar sealing elements, one or more of sealing elements having a higher compressibility than adjacent sealing elements of relatively low compressibility;
wherein the sealing elements of relative low compressibility are configured to maintain a fixed spacing to limit compression of the one or more sealing elements of relatively high compressibility provided therebetween.

2. The composite sealing component according to claim 1, wherein the sealing elements of relative low compressibility take the form of a series of flanges, between which the sealing elements of relative high compressibility are provided.

3. The composite sealing component according to claim 1, wherein the sealing elements of relative low compressibility are formed by machining circumferential slots into the periphery of a solid ring to define said series of flanges.

4. The composite sealing component according to claim 1, wherein a plurality of sealing elements of relative low compressibility are coupled together, one or more of the facing surfaces of the sealing elements of relative low compressibility being profiled to define said spacing there-between.

5. The composite sealing component according to claim 4, wherein certain of the sealing elements of relative low compressibility have a stepped profile to define slots for housing said sealing elements of relative high compressibility.

6. The composite sealing component according to claim 1, wherein support spacers provided between the sealing elements of relative low compressibility, the support spacers keeping the sealing elements of relative low compressibility apart to define slots for housing the sealing elements of relative high compressibility.

7. The composite sealing component according to claim 6, wherein the sealing elements of relative low compressibility and support spacers are rings, with the support spacers having a reduced outer diameter compared with the sealing elements of low compressibility.

8. The composite sealing component according to claim 4, wherein the sealing elements of relative high compressibility are interleaved with the sealing elements of relative low compressibility to form a composite stack.

9. The composite sealing component according to claim 8, wherein the sealing elements of relative low and high compressibility are coupled together with adhesive.

10. The composite sealing component according to claim 1, wherein the composite sealing component is a sealing ring.

11. The composite sealing component according to claim 1, wherein three to five sealing elements of relative high compressibility are provided within the composite sealing component.

12. The composite sealing component according to claim 12, wherein three sealing elements of relative high compressibility are supported by four sealing elements of relative low compressibility.

13. The composite sealing component according to claim 4, wherein if there are n sealing elements of relative high compressibility, n of the n+1 sealing elements of relative low compressibility are profiled on one face.

14. The composite sealing component according to claim 1, wherein the sealing elements of relative high compressibility are formed of any one of graphite, PTFE, PVC or rubber.

15. The composite sealing component according to claim 1, wherein the sealing elements of relative low compressibility are formed of any one of Steel, 316L Stainless Steel, Inconel, Duplex, Alloy Bronze.

16. The composite sealing component according to claim 1, wherein the sealing component outer profile presents a flush surface across the different planar sealing elements of relative low and high compressibility.

17. A method for assembling a butterfly valve having a composite sealing component according to any preceding claim, the method comprising the steps:
installing the composite sealing component in position in the valve on the valve's disc body;
partially tightening a disc seal cover plate so that the composite sealing component is free to move into the correct position when the disc assembly comprising the disc body and composite sealing component is rotated by the valve shaft to the closed position correctly aligning the composite sealing component against a valve body seat;
closing the valve with a minimum torque setting to ensure correct seal assembly alignment and test for leakage,
repeating the open/close/leakage test process with increasing torque up to 75% MAST;
fully tightening the disc seal plate to hold the composite sealing component in position once alignment is confirmed and all air leaks are eliminated.
